(19) United States
(12) Patent Application Publication
(10) Pub. No.: US 2008/0308094 A1
(43) Pub. Date: Dec. 18, 2008

(54) TROUGH REFLECTORS FOR SOLAR ENERGY COLLECTORS

(76) Inventor: Glen JOHNSTON, Bungendore (AU)

Correspondence Address: BERENATO, WHITE & STAVISH, LLC, 6550 ROCK SPRING DRIVE, SUITE 240, BETHESDA, MD, 20817, US

(21) Appl. No.: 12/194,696

(22) Filed: Aug. 20, 2008

Related U.S. Application Data
(63) Continuation of application No. PCT/AU07/00095, filed on Feb. 2, 2007.

(30) Foreign Application Priority Data
Feb. 3, 2006 (AU) 20069200512

(51) Int. Cl. F24J 2/12; B23P 11/00; B23P 15/26; G02B 5/10

(52) U.S. Cl. 126/694; 29/457; 29/525.11; 29/890.033; 359/867

(57) ABSTRACT

A trough reflector for solar energy collection is constructed from transverse ribs which support a reflective surface. Side edge support rails mounted on ends of the ribs support linear edges of the reflective surface. The edge support rails have a channel-like construction with an inner flange member which is in contact with a top of the reflective surface, and a lip member extending from an outer flange member. The edge region of the reflective surface rests on the lip member with the edge of the reflective surface in contact with the outer flange member. A turning moment is applied to the edge regions of the reflective surface to ensure that the entire reflective surface is parabolic. An arcuate profile of ribs of the trough reflector is converted into a parabolic profile by the application of a force to the ends of the ribs.

### TECHNICAL FIELD

This invention concerns solar energy concentrators. More particularly, it concerns trough reflectors which are used to concentrate solar energy, and solar energy collectors which include such trough reflectors.

### PRELIMINARY NOTE

In this specification, including the claims, “directional” terms (such as “top”, “bottom”, “side”, “underside”, “upper”, “lower”, “front”, “back”, “above”, “upwards”, “below”, “Vertical”, “horizontal” and the like) will be used in the sense that these terms would have with reference to an embodiment of the invention positioned as shown in FIG. 8 and FIG. 9 of the accompanying drawings.

### BACKGROUND TO THE INVENTION

Trough reflectors or trough concentrators of solar energy have been known for a considerable time. For example, a trough reflector is described in the paper by Frank Shuman, presented to the Manchester Association of Engineers on 14 Mar. 1914, and published in the Proceedings of the Manchester Association of Engineers, (Discussion Session 1913-1914), No. 9, page 405 et seq. More recently, trough reflectors have been described in the specifications of US patents Nos.:

U.S. Pat. No. 4,071,017 (1978; to John L Russell, Jr. and Robert Edward Potthof);

U.S. Pat. No. 4,106,484 (1978; to Richard E Dame);

U.S. Pat. No. 4,119,365 (1978; to Roger Andrew Powell);

U.S. Pat. No. 4,390,241 (1983; to John M Trihey);

U.S. Pat. No. 4,559,926 (1985; to Barry L Butler);

U.S. Pat. No. 4,571,812 (1986; to Randall C Gee); and

U.S. Pat. No. 4,820,033 (1989; to Erwin Sick).

A trough reflector (collector) comprises a trough-like reflecting surface which has a transverse cross-sectional profile that is parabolic, or approximately parabolic (other acceptable profiles can include a profile which is an arc of a circle or a hyperbolic profile). Trough reflectors are used to focus radiation from the sun onto a linear receiver, which is, typically, an absorber tube. The most efficient trough reflectors are mounted in such a manner that they are moved, during the course of a day, to present a maximum area to the sun at all times (that is, they “track” the sun). To do this, the reflector can be rotated about one axis or two axes. Single axis tracking of the sun is generally effected by rotation of the collector system about a horizontal axis, while two-axes tracking can be achieved by simultaneous rotation about both a horizontal axis and a vertical axis.

To be most cost effective, a solar energy collector which incorporates a trough reflector should be a structurally rigid, easily assembled and easily serviced collector which is economical to construct and relatively lightweight.

Trough reflectors having these characteristics have been constructed by mounting a rectangular, highly reflective surface on a series of curved ribs. The top surfaces of these ribs define, or approximately define—together with the top surfaces of several linear beams that also support the reflective surface—the envelope shape of the trough reflector. Other examples of trough reflectors for concentrators of solar energy which have a concave, preferably parabolic, reflective surface are described in each of the specifications of the US patents mentioned above (in the case of the specification of U.S. Pat. No. 4,119,365 only with reference to FIG. 10 of that specification).

The reflective surface of all these examples of trough reflectors is usually constituted by a single reflective sheet. However, the reflective surface may comprise a number of individual highly reflective panels.

If reflective panels are used, they should each be a rectangular panel (although, the panels may have other perimetric shapes). Each reflective panel will have a surface which is highly reflective of solar energy, or will have a surface to which such a highly reflective surface is bonded. In general, a panel will have a significant thickness and will be stiff enough to maintain a desired shape with minimal, or with no, support from supporting members or elements.

If a single reflective sheet is used, it will generally be a rectangular sheet (although it may have a perimetric shape which is not rectangular) of a thin material which has a surface that is highly reflective to solar energy, or to which such a reflective surface is bonded. Such a sheet is generally flexible and will not maintain a specific profile unless it is constrained to have that profile, for example, by supports on which the sheet is placed. The same problem exists when a number of thin reflective sheets are placed on the top surfaces of a large (in area) array of curved ribs.

Accordingly, almost all trough reflectors that are constructed using thin, highly reflective sheets have linear rails or supports for the sheets at the straight side edges of the trough reflector. (Some trough reflectors have additional supports that are orthogonal to the elongate direction of the ribs, between the edge rails.)

It has been known for some time that the side edge rails or supports ensure that there is no sagging of the edge of the reflective sheet in the space between adjacent ribs. More recently, it has been shown that when a thin reflective sheet is laid on ribs, each having an upper surface profile which is parabolic, to the ends of which a side edge support rail is connected, the reflective sheet has a generally parabolic profile, but the edge regions, adjacent to the side support rails, are not truly parabolic. Therefore, to achieve maximum efficiency of the reflective surface, with regard to the collection of solar energy, the side edge regions of the sheet must be altered so that they also conform to the overall parabolic profile. This control of the edge regions is effected by applying an edge correction moment to the edge regions.

One technique for applying edge correction moments is described in the specification of U.S. Pat. No. 4,106,484 (mentioned above). This specification uses controlled rotation of rectangular side edge supports to modify the shape of the reflective sheet of a trough reflector. More recently, a different approach to the control of the edge region of a reflective sheet has been described in WIPO Publication No. WO 03/022578, which is the specification of International patent application No. PCT/AU02/01243, filed by The Australian National University. Edge control moments could also be applied—in principle, at least—to the reflective sheet used in the trough reflector illustrated in the specification of U.S. Pat. No. 4,820,033, using the adjustment screw 41 of the clamping arrangement that is mounted on the edge supports (and clamping section carriers) 11 of that trough reflector. Both of these last two edge region profile correction arrangements are quite complex and, it appears, are not used in currently marketed solar energy collectors having trough reflectors.

### DISCLOSURE OF THE PRESENT INVENTION

The primary objective of the present invention to provide a simple and effective method of applying an edge correction moment to a thin reflective sheet that is mounted on an array of ribs, each rib having an upper surface profile which is a parabola.

A secondary objective of the present invention is the provision of a method of constructing a low cost, lightweight, yet rigid, trough reflector for a solar energy collector.

A tertiary objective of the present invention is the provision of a rigid, lightweight, easily assembled and easily serviced solar energy collector, which can be used to track the sun using either the single axis tracking technique or the dual axis tracking technique.

The primary objective is achieved by the use of a novel edge support rail for the metal sheet of a trough reflector that is mounted on the ends of the ribs of the trough reflector, and that can be used to apply an edge correction moment to the edge regions of the sheet.

The novel edge support rail has a cross-sectional shape that comprises
1. a planar web member
2. an inner flange member and an outer flange member, each flange member extending orthogonally from a respective edge of the web member, to form a pair of parallel flange members; and
3. a lip member extending orthogonally from the edge of the outer flange member which is remote from the web member, a short distance towards the inner flange member.

One commercially available product that can be used as an edge support rail (which has an additional lip member and two additional flanges at the edges of its lip members) is the Unistrut P3300 (“Unistrut” is a trade mark), or another suitable “Unistrut” rail product.

To construct a trough reflector using the novel side edge rail, a number of the ribs are positioned on a jig or on a support structure so that their concave, parabolic surfaces
1. are facing upwards, and
2. define the envelope of the profile of the trough reflector.

In this position, the ribs form a trough-shaped support structure. The reflective sheet is laid on the upper, concave surfaces of the ribs. The sheet sags until it is supported on the top surfaces of the ribs. The reflective, trough-like surface formed by the sheet has two arcuate edges that are supported by the end ribs, and two linear edges that are adjacent to, but inwards of, the tips or ends of the parabolic ribs. Each end region of the ribs which is not overlaid by a reflective sheet has an aperture extending at least partially through the rib from the top surface thereof.

The edge support rails are then mounted on, but above and near the tips of, the arcuate ribs to support the linear edges of the reflective surface. Each edge support rail is a linear member—preferably of metal—which has the cross-sectional shape defined above. Each edge support rail is positioned with its lip member underneath a linear edge of the reflective surface and with the end of its inner flange member resting on the top of the reflective surface.

Each edge support rail is connected to each rib that it overlies by a bolt that passes through a clearance aperture in the web member of the edge support rail, then through a clearance aperture in the reflective surface, to enter and engage with an internally threaded cylindrical aperture which extends into the associated rib from its upper surface. The internally threaded cylindrical aperture may be provided by a captive nut in the top surface of the associated rib, or an equivalent component contained within or below the associated rib.

To enable the edge support rails to be so bolted to the arcuate ribs of the support frame, that part of the lip member which is above an arcuate rib (and, if necessary, a portion of the correspondingly located outer flange member) is removed, forming a series of cut-out sections in each edge support rail. This ensures that the reflective sheet is in contact with the top surface of the ribs when each edge support rail is positioned on the support frame and is bolted to the ribs. The cut-out sections in the edge support rails also allow the edge support rails to apply a twisting force, or moment, to the edge of the sheet reflector, to control the shape of the sheet reflector at its side edges.

Initially, the bolts used to mount the edge support rails on the ribs of the trough reflector are not fully tightened, but are screwed into their associated captive nuts or internally threaded apertures only until the edge support rails are held in position with
1. the lower end of the inner flange (the end that is remote from the web member) resting on the top surface of the reflective sheet;
2. the edge region of the reflective sheet resting on the lip member; and
3. the edge of the reflective sheet in contact with the inner surface of the outer flange of the edge support rail.

Further tightening of the mounting bolts now has the effect of
1. causing each inner flange member of the support rails to apply a downwards force onto the linear edge region of the reflective sheet which is inside the mounting bolts, and
2. causing each lip member to apply an upwards force to the linear edge region of the reflective sheet which overlies the lip member.
   thus applying a turning moment to the linear edge regions of the reflective surface. This turning moment provides a correction to the profile of the reflective surface at its linear edge regions (which, without this turning moment, are not truly parabolic), thus making the entire reflective surface essentially parabolic.

Thus, according to the present invention, a method of constructing a trough reflector for a solar energy collector comprises the sequential steps of
1. positioning a linear array of spaced apart, transverse ribs on a jig, each rib having a top surface that has a profile which is a parabola; each rib having an aperture adjacent to each end of the rib, each aperture extending at least partially through the rib from the top surface thereof;
2. positioning a reflective surface comprising at least one rectangular sheet having an upper surface which is highly reflective of solar energy on said ribs, said reflective surface having dimensions such that, when so positioned, it is in contact with said top surfaces of said ribs, with parabolic end edges and with substantially linear side edges; said side edges being positioned adjacent to but inwardly of the respective ends of said ribs;
3. positioning at least one side edge support rail on each of said linear side edges, said at least one side edge support rail being positioned adjacent to respective ends of said ribs; each side edge support rail comprising an elongate metal strut which has a cross-sectional shape that comprises
   (a) a planar web member;
   (b) an inner flange member and an outer flange member, each of said flange members extending orthogonally from a respective edge of said web member, to form a pair of parallel flange members; and
   (c) a lip member extending orthogonally from the edge of said outer flange member which is remote from said web member, a short distance towards said inner flange member;
each side edge support rail having a portion of its lip member removed from each region of said side edge support rail which overlies one of said ribs; each side edge support rail being positioned to have at least one respective linear edge of said reflective surface positioned on its lip member and in contact with its outer flange member; said mounting of said side edge support rails being effected by a plurality of bolts, each of said bolts being passed through a respective clearance aperture in said web member of one of said side edge support rails, and through, a clearance aperture in said reflective surface adjacent to one of said linear side edges, to enter one of said apertures in said ribs and engage with threads which are formed in said apertures in said ribs or are provided by a nut, said bolts being lightly tightened;
4. further tightening of said mounting bolts to cause each inner flange member of said support rails to apply a downwards force onto said linear edge region of the reflective sheet which is inside the mounting bolts, and to cause each lip member to apply an upwards force to said linear edge region of the reflective surface which overlies said lip member, thereby applying a turning moment to said linear edge regions of said reflective surface to make said reflective surface conform closely to the parabolic shape of said upper surface of said ribs.

The invention also encompasses a trough reflector made by this method.

It is known that it is possible to produce a parabolic profile from metal ribs that have been rolled to have a circular arcuate profile. Since the production of rolled metal ribs with a circular arcuate profile is a relatively low cost procedure, the present inventor has extended the application of the novel edge support rail to achieve the secondary objective of the present invention with a trough reflector having a transversely parabolic reflecting surface which comprises an assembly of
1. ribs which initially have an arcuate profile,
2. a solar energy reflective sheet or a plurality of reflective sheets or panels,
3. linear edge support rails, and
4. chordal straps.

To realise this second aspect of the present invention, the arcuate ribs of the trough reflector will normally be lengths of a flexible and resilient material, typically (but not necessarily) a metal which have been formed (rolled in the case of a metal) so that the uppermost surface of each rib is concave and has a profile that is an arc of a circle. Each end region of the ribs which is not overlaid by a reflective sheet has an aperture extending at least partially through the rib from the top surface thereof.

An array of the arcuate ribs are positioned on a jig or on a support structure so that their concave surfaces
1. are facing upwards, and
2. define the envelope of the initial profile of the trough reflector.

In this position, the ribs form a trough-shaped support structure. The reflective sheet or the reflective panel elements are laid on the upper, concave surfaces of the ribs so that the ribs are mostly covered by the reflective sheet or panels but the end regions of the ribs are not covered. Each end region of the ribs which is not overlaid by a reflective sheet or panel has an aperture extending at least partially through the rib from, the top surface thereof.

If rectangular reflective panel elements are used,
1. the edges of adjacent panels will abut against each other, and
2. the spacing of the ribs will be such that the panels—appropriately bent, if necessary—are supported along two opposed peripheries on respective ribs.

If a reflective sheet is used, the sheet sags until it is supported on the arcuate top surfaces of the ribs. The reflective, trough-like surface formed by the sheet or the panels has two arcuate edges that are supported by the end ribs, and two linear edges that are adjacent to, but inwards of, the tips or ends of the arcuate ribs.

Edge support rails are then mounted above, and near the tips of, the arcuate ribs to support the linear edges of the reflective surface. Each edge support rail is a linear member—preferably of metal—which has the cross-sectional shape defined above, namely, it comprises
1. a planar web member;
2. an inner flange member and an outer flange member, each flange member extending orthogonally from a respective edge of the web member, to form a pair of parallel flange members; and
3. a lip member extending orthogonally from the edge of the outer flange member which is remote from the web member, a short distance towards the inner flange member.

Each edge support rail is positioned with its lip member underneath a linear edge of the reflective surface and with the end of its inner flange member resting on the top of the reflective surface. Each edge support rail is connected to each rib that it overlies by a bolt that passes through a clearance aperture in the web member of the edge support rail, then through a clearance aperture in the reflective surface, to enter one of said apertures in said ribs and engage with threads which are formed in the aperture in the rib or are provided by a nut. The nut may be a captive nut in the top surface of the rib, or a nut held captive in an interior cavity of the rib, or it may be a separate nut which is engaged by the bolt after passing though an aperture that extends completely through an end of the rib.

To enable the edge support rails to be so bolted to the arcuate ribs of the support frame, that part of the lip member which is above an arcuate rib (and, if necessary, a portion of the correspondingly located outer flange member) is removed, forming a series of cut-out sections in each edge support rail. This ensures that the metal sheet is in contact with the top surface of the ribs when each edge support rail is positioned on the support frame and is bolted to the ribs. The cut-out sections in the edge support rails also allow the edge support rails to apply a twisting force, or moment, to the edge of the sheet reflector, to control the shape of the sheet reflector at its side edges.

Initially, the bolts used to mount the edge support rails on the ribs of the trough reflector are not fully tightened, but are screwed into their associated captive nuts or internally threaded apertures only until the edge support rails are held in position. Tensioning devices are then used to pull the opposed tips of each arcuate rib towards each other. The known consequence of this action is to cause the arcuate upper profile of each rib to adopt, after a predictable movement of the tips of the rib, a parabolic or essentially parabolic shape. Such modification of a resilient rib profile has been described in the aforementioned specification of U.S. Pat. No. 4,571,812 to Randall C Gee.

When the tips of the ribs have been displaced by most, but not all, of the distance required for the rib profile to become parabolic, the bolts mounting the edge support rails on the ribs are tightened
1. to fix and clamp the linear edges of the reflective surface firmly between the edge support rails and the ribs, and
2. to apply a turning moment to the edge region of the reflective surface (in the manner explained above).

The tensioning devices are then used to move the rips of the ribs further towards each other, until the upper surfaces of the ribs have achieved their final, parabolic profile. The final movement of the tips of the ribs causes the outer flange of the edge support rail to move slightly and apply a transverse force to the reflective surface. The application of this transverse force makes the reflective surface conform closely to the parabolic shape of the upper surface of the ribs, and ensures that, unless the mounting bolt is unscrewed, removal of the reflective surface from the ribs can only be achieved by the use of a significant force.

A respective “chordal strap”, which is preferably a thin metal rod, is then connected between the ends of each rib, to hold each rib in the position in which its upper, concave surface has a parabolic profile (or an essentially parabolic profile), and the rib-tensioning devices are relaxed and removed.

The trough reflector so formed is a rigid, lightweight reflector that can be removed from its jig and incorporated into a solar energy collector.

Thus, according to the second aspect of the present invention, a method of constructing a trough reflector for a solar energy collector comprises the sequential steps of:
1. positioning an array of spaced apart, flexible and resilient, transverse ribs on a jig; each rib having a top surface that has a profile which is an arc of a circle; each rib having an aperture adjacent to each end of the rib, each aperture extending at least partially through the rib from the top surface thereof;
2. positioning a reflective surface comprising either a rectangular sheet having an upper surface which is highly reflective of solar energy or a plurality of panels each having an upper surface which is highly reflective of solar energy on said ribs, said reflective surface having dimensions such that, when so positioned, it is in contact with said top surfaces of said ribs, with arcuate end edges and with substantially linear side edges; said side edges being positioned adjacent to but inwardly of the respective ends of said ribs;
3. positioning at least one side edge support rail on each of said linear side edges, said at least one side edge support rail being positioned adjacent to respective ends of said ribs; each side edge support rail comprising an elongate metal strut which has a cross-sectional shape that comprises
   (a) a planar web member;
   (b) an inner flange member and an outer flange member, each of said flange members extending orthogonally from a respective edge of said web member, to form a pair of parallel flange members; and
   (c) a lip member extending orthogonally from the edge of said outer flange member which is remote from said web member, a short distance towards said inner flange member;
each side edge support rail having portions of its lip member removed to form respective cut-outs from the regions of said side edge support rail which overlie said ribs; each side edge support rail being positioned to have at least one respective linear edge of said reflective surface positioned on its lip member and in contact with, or close to, its outer flange member; said mounting of said side edge support rails being effected by a plurality of bolts, each of said bolts being passed through a respective clearance aperture in said web member of one of said side edge support rails, and through a clearance aperture in said reflective surface adjacent to one of said linear side edges, to engage with threads which are formed in said apertures in said ribs or are provided by a nut, said bolts being lightly tightened;
4. applying a force progressively to each end of each rib in the direction of the other end of the rib, to reduce the distance apart of the ends of each rib and to change the shape of said top surface of each rib from substantially an arc of a circle to substantially parabolic; but holding said applied force at a value less than the force required to cause the top surface of each rib to be parabolic;
5. tightening said bolts to apply a turning moment to the edge regions of said reflective surface;
6. continuing the progressive application of said force until the top surface of each rib becomes parabolic, whereby said reflective surface is fixed against said top surfaces of said ribs;
7. connecting a respective chordal strap to each end of each rib to hold its associated rib in the shape reached at the conclusion of the application of said force, then
8. relaxing and removing said force.

These steps can also be undertaken with metal sheets or panels that do not have a reflective upper surface. In this situation, to produce a trough reflector, a reflective material will be applied to the upper surface of the metal sheet or the panels after the steps recited in the last preceding paragraph have been completed.

The present invention also encompasses a trough reflector constructed in accordance with the second aspect of the present invention.

An elongate trough reflector may be constructed by bolting together adjacent end ribs of two or more aligned trough reflectors, constructed in accordance with the present invention.

To achieve the objective of the tertiary aspect of the present invention, the trough reflector formed by the first or second aspect of the present invention, as described above, is mounted on a space frame that is supported by at least two hoop members.

In one form of this aspect of the invention, each hoop member rests on a respective guide and support wheel and on the top of a respective pinch roller and the pinch rollers are connected together by a torque tube.

In another form of this aspect of the invention, one hoop member rests on a respective guide and support wheel, and on top of a pinch roller, while the second (and any subsequent) hoop members are supported on guide and support wheels only. No torque tube is required for this form of the invention.

The axes of rotation of the hoop members are co-linear, so rotation of the pinch rollers causes the hoop members to be rotated simultaneously about a horizontal axis, and consequently the trough reflector is also rotated about a horizontal axis. Such rotation of the trough reflector may be used for single axis tracking the sun. For two-axes tracking of the sun, the entire assembly of trough reflector, space frame and rotatable hoops may be mounted on a base frame that is rotatable about a vertical axis.

Embodiments of the present invention will now be described, by way of example only. In the following description, reference will be made to the accompanying drawings.

### BRIEF DESCRIPTION OF THE ACCOMPANYING DRAWINGS

FIG. 1 is a perspective sketch of an array of arcuate ribs having various cross-sectional profiles.

FIG. 2 shows a reflective surface, composed as an array of reflective sheets, of a trough reflector, positioned on an array of ribs, which ribs can have the profiles of the ribs shown in FIG. 1.

FIG. 3 is a partly schematic sectional view through the end of a rib of the support frame and through a side edge support rail, which illustrates how a side edge support rail is mounted on a rib of the support frame.

FIG. 4 consists of three transverse sectional views of alternative side edge support rail configurations.

FIG. 5 is a perspective view of an edge support rail, showing cut-outs to accommodate the tips of respective ribs.

FIG. 6(a) depicts one end of one form of a tensioning device for applying a transverse force to the ends of the ribs of a trough reflector, prior to the attachment of a chordal strap, while FIG. 6(b) shows a perspective view of the tensioning device applied to an arcuate rib.

FIG. 7(a) and FIG. 7(b) depict two forms of chordal strap.

FIG. 8 is a perspective sketch of a preferred form of solar energy concentrator which includes the trough reflector of the present invention.

FIG. 9 is a perspective sketch of yet another form of solar energy concentrator which includes the trough reflector of the present invention.

FIG. 10 is a perspective sketch showing a preferred arrangement by which the hoop members of the solar energy concentrator depicted in FIG. 8 and FIG. 9 are rotated.

FIG. 11 to FIG. 15 show alternative hoop (42) cross-sections and pinch roller drive configurations (53 and 57) for the solar energy concentrators that are illustrated in FIG. 8 and FIG. 9.

### DETAILED DESCRIPTION OF THE ILLUSTRATED EMBODIMENTS

A trough reflector constructed in accordance with the first aspect of the present invention has ribs which have been pre-formed to have a parabolic upper surface profile. Such ribs may comprise ribs that have been worked to have a parabolic upper surface, or they may be constructed from thick or thin panels of metal, of a suitable plastics material, or of another suitable material. (A similar “non-rod” rib construction is shown in the aforementioned specifications of U.S. Pat. Nos. 4,390,241 and 4,820,033.) A rib which supports a reflective surface may also be formed by pressing tabs (which follow a parabolic curve) from thin metal panels, and supporting the reflective surface between the tabs, (Such a pressed-tab construction is illustrated in the aforementioned WIPO Publication No, WO 03/022578.) Alternatively, the tabs may be small pieces of a suitable material attached to a panel (such small pieces in this specification will be termed ‘tabs’).

At least one reflecting sheet is supported on the upper, parabolic surfaces of the ribs of the first aspect of the invention. The edge regions of the sheet or sheets are made truly parabolic by the application of a turning moment, using the novel form of side edge support rail, which is bolted by the ribs. This step produces the trough reflector.

This application of a turning moment using the side edge support rail, is also a feature of the second aspect of the present invention. Since an embodiment of the second aspect of the invention is described in detail below, additional description of an embodiment of the first aspect of the invention is not necessary.

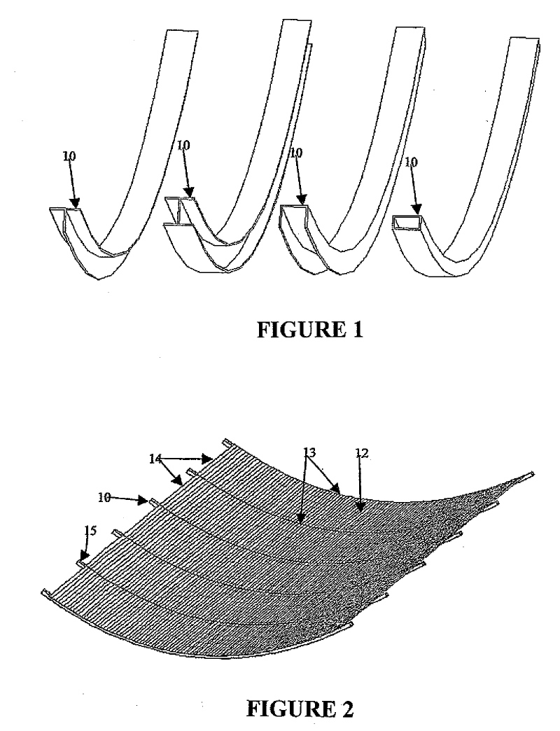

Turning now to the illustrated embodiment of the second aspect of the present invention, FIG. 1 shows a number of flexible and resilient metal—preferably steel or an aluminium alloy—beams that have been rolled so that their upper surfaces have a profile that is an arc of a circle. These beams are used as the ribs of the trough reflector of the second aspect of the present invention and are depicted in FIG. 1 as an array of ribs in the positions they will have when mounted on a jig (not shown) at the start of the assembly of a trough reflector. Normally, each rib will have the same cross-sectional shape. The different cross-sections of the ribs in FIG. 1 demonstrate the fact that there are many suitable cross-sections for resilient and flexible metal ribs, including a hollow rectangular (which includes square) cross-section, a “T” cross-section, an “T” cross-section and a “C” cross-section. In principle, though it is not preferred, the rib may have a solid rectangular cross-section. Steel beams with these cross-sections are readily available commercially. This list of possible cross-sections for the arcuate ribs is not exhaustive.

Beams with other cross-sections may be used to construct the ribs 10 of the trough reflector. Materials other than metal (for example, some plastics materials) may be used for the arcuate ribs. If the ribs are rods constructed of a plastic material, they will normally be moulded (and not rolled) so that the upper surface of the ribs has the profile of an arc of a circle.

Each rib shown in FIG. 1 has been rolled to the same constant radius of curvature and is mounted on the jig so that it is a transverse rib of the trough reflector. When so mounted, the top surfaces of the ribs define the envelope of the reflective surface of the solar energy reflector.

FIG. 2 shows an array of reflective sheets 12 positioned on the ribs. The reflective sheets have been shown to demonstrate the preferred way of constructing a large reflector, which is to mount a plurality of reflective sheets on the ribs 10. However, a single reflective sheet may be used as the reflecting surface of the present invention, as may a plurality of smaller panels—preferably rectangular panels. The nature of the metal sheets 12 is such that, when assembled as shown in FIG. 2, gravity causes each metal sheet to sag until it contacts the top surfaces of the array of ribs 10. Thus each metal sheet 12, and the entire reflecting surface, when on the support frame, has curved (arcuate) end edges 13 and substantially linear side edges 14. If panels with a reflective face are used to construct the reflecting surface, the panels may need to be bent to have an arcuate profile before being laid on the ribs, with the edges of adjacent panels abutting each other, to form a continuous reflecting surface for the trough reflector. Each panel will need to have a rib supporting the panel at its curved edge.

The upper surface of each sheet 12 (and of each panel if panels are used) is highly reflective of solar energy. The reflective nature of the upper surface may be established by using a highly polished metal sheet or panel (to produce, for example, a highly polished sheet or panel of aluminium or of stainless steel). Alternatively, the reflective nature of the upper surface may be established by bonding thin silver-backed or aluminum-backed glass mirrors to a sheet metal substrate (such as a sheet or panel of plain steel, of an aluminium alloy, of galvanised steel, or of painted steel). Such laminates can be bonded together using mechanically applied or sprayed on liquid adhesives, contact or pressure sensitive adhesives, or fusible film type adhesives. (These alternative laminate constructions are not exhaustive.) Such laminates are preferably made before the trough reflector is constructed.

As will be seen in FIG. 2, the linear edges 14 of each metal sheet 12 are close to, but are spaced from, the ends of the ribs 10. A respective aperture 15 extends into the top surface of each end of each rib 10 mat is not covered by the reflective surface. Each aperture 15 may be a circular aperture (in which case it can be internally threaded so that a bolt can be screwed into it), or it may retain a captive nut, or it may be an aperture that extends though the end of a rib so that the shank of a bolt may pass through, to permit a fixing nut to be threaded onto the bolt FIG. 2 also shows the preferred arrangement in which the arcuate end edges 13 of the metal sheets 12 are positioned above a respective rib 10 of the support frame.

Edge support rails 20 are now mounted on the ribs 10. One long edge support rail may be used on each side of the trough reflector, or a number of shorter edge support rails 20 may be used. Each edge support rail 20, when hi place,
1. provides support for a linear edge of at least one metal sheet 12,
2. increases the rigidity of the trough reflector structure, and
3. provides a means of applying an edge moment, if required, to a sheet reflector.

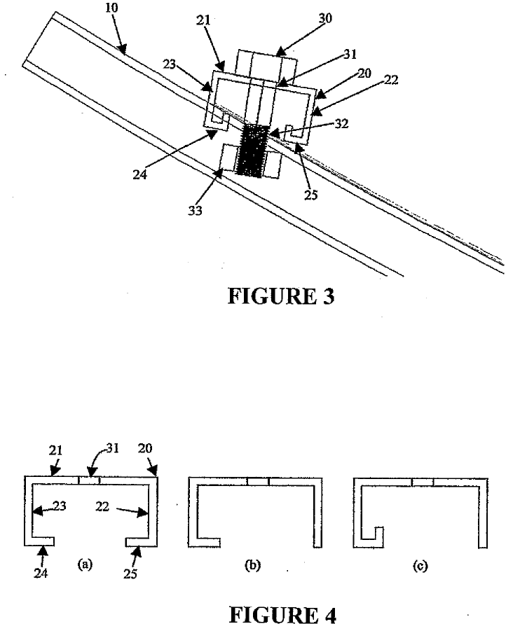

Each edge support rail (as already noted above) has a cross-sectional shape which, as shown in FIG. 3, comprises
1. a planar web member 21;
2. an inner flange member 22 and an outer flange member 23, each flange member extending orthogonally from a respective edge of the web member 21, to form a pair of parallel flange members; and
3. a lip member 24 which extends orthogonally from the edge of the outer flange member which is remote from the web member 21, a short distance towards the inner flange member 22.

It will be appreciated that this cross-sectional shape is essentially a “C” section with the arms of the “C” establishing the flange members 22 and 23, and with the lip member 24 formed integrally with, or by an attachment to (for example, by welding if the edge support rail 20 is of steel) the edge of the outer flange member 23. The edge support rail 20 may be formed as a rigid extrusion (for example, an extrusion of steel or an aluminium alloy, or other rigid material).

The edge support rail 20 shown in FIG. 3 is a commercially available strut marketed under the trade mark “Unistrut P3300”. This “Unistrut” strut is most advantageous because, in addition to its commercial availability, the presence of the additional return lip and flanges increases the rigidity of the edge support rails.

Three alternative cross-sectional shapes of an edge support rail are shown in FIG. 4(a), (b) and (c).

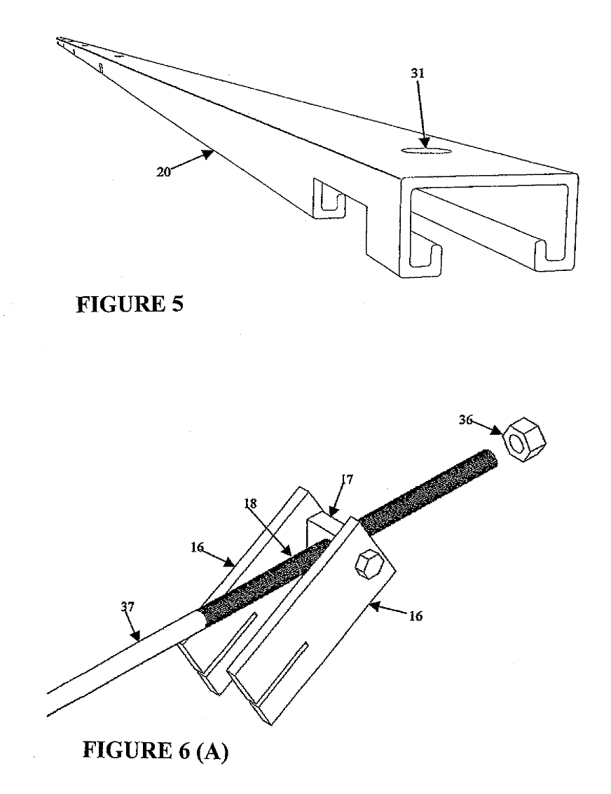

Each edge support rail 20 has a portion of its lip member 24 and a portion of its outer flange 23 removed (or cut out) from the support rail where the edge support rail passes over a rib of the support frame, as shown in FIG. 5. This cut-out enables the edge support rail 20 to fit over the ribs 10 and for the linear side edges 14 of the metal sheet 12 to rest on and be supported by the remainder of the lip member 24—which is, of course, most of the lip member 24. (The cut-out region also enables the edge support rail to apply edge moments to the reflective sheet.) In this position, the linear side edge 14 will also be in contact with the inner face of the outer flange member 23 of the support rail 20.

When in position, the edge support rails 20 are lightly bolted to the ends of the ribs 10 of the support frame, using bolts 30. Each bolt 30 passes through a clearance aperture 31 in the web member 21 of the edge support rail, then through a clearance aperture 32 (see FIG. 3) in the reflective surface, to enter an aperture in the end of a rib, where it (1) engages with the internal thread of that aperture, (2) engages with the thread of a captive nut 33 (see FIG. 3) in the aperture of the rib 10, or (3) passes through the aperture in the end of the rib so that an external nut may be applied to (screwed onto) the threaded end of the bolt which extends below the rib 10.

When each edge support rail 20 has been lightly bolted to the ribs 10 of the support frame, a tensioning device is used to progressively pull the opposed tips of each arcuate rib towards each other.

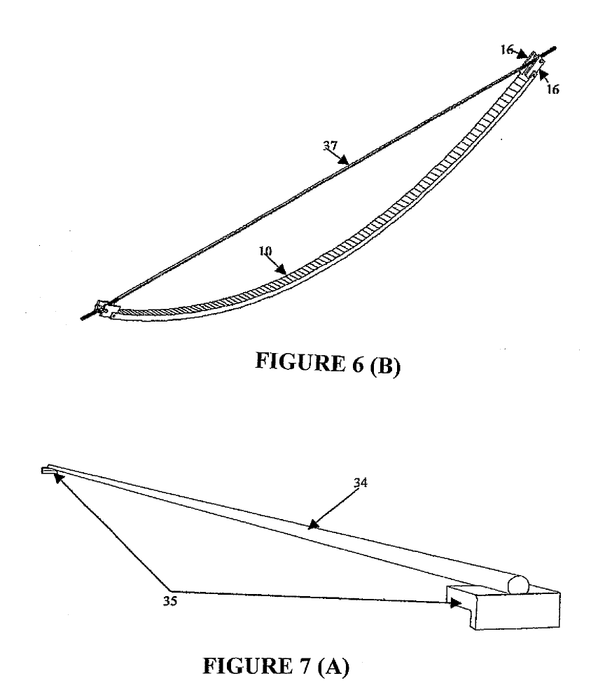

FIG. 6(a) shows one end of one such tensioning device. (The other end is similarly configured.) A pair of metal side arms 16 are bolted to a spacer block 17 which has an aperture 18 passing through it. The aperture 18 is a clearance aperture for a rod 37 that has at least its end regions threaded. The spacer block 17 has dimensions such that it separates the side arms 16 by a distance which
1. permits the end of a rib 10 to be operatively engaged within a slot 19 in each of the side arms 16, and
2. permits the rod 37 to be passed through the aperture 18.

A respective nut 36 is threaded onto each end of the rod 37. Tightening the nuts 36 causes the distance between the two spacer blocks 17 of the device to be reduced, and thus a force to be applied, via the side arms 16, to the ends of the ribs. FIG. 6(b) shows the tensioning device applied to an arcuate rib.

Other types of tensioning device may be used instead of the device illustrated in FIG. 6.

As noted above, it is known that the consequence of this progressive application of a tensioning force to the ribs is to cause a perturbation of the arcuate upper profile of each rib until it becomes, after a predictable movement of the tips or ends of the rib, a profile that is parabolic or is essentially parabolic in shape.

When the tips of the ribs have been displaced by most, but not all, of the distance required for each rib profile to become parabolic, the progressive movement of the ends of the ribs is temporarily halted and the bolts 30, mounting the edge support rails 20 on the ribs 10, are tightened to fix and clamp the linear edges of the reflective surface firmly between the edge support rails 20 and the ribs 10. Tightening the bolts 30 also applies a turning moment to each linear edge region of the (or each) metal sheet 12. (The application of this turning moment has been described previously in this specification.)

The tensioning devices are then used to move the tips of the ribs further towards each other, until the upper surfaces of the ribs have a parabolic profile. The combination of the tightening of the bolts 30 and this final movement of the tips of the ribs applies a transverse force to the reflective surface, which forces the reflective surface down into the ribs and mates the reflective surface conform closely to the shape of the upper surface of the ribs. An additional consequence of this further application of a transverse force is that, unless the bolts 30 are loosened, the reflective surface can be removed from the ribs only by the application of a significant force (so that, in effect, the reflective surface is fixed against the top surfaces of the ribs).

When this final movement of the tips of the ribs has been effected and the arcuate profile of the upper surface of the ribs has been changed into a parabolic profile, a respective “chordal strap” 34 is connected between the ends of each rib, to hold each rib in that position (that is, with its upper, concave surface having a parabolic profile or an essentially parabolic profile) when the force applied by the tensioning devices is removed.

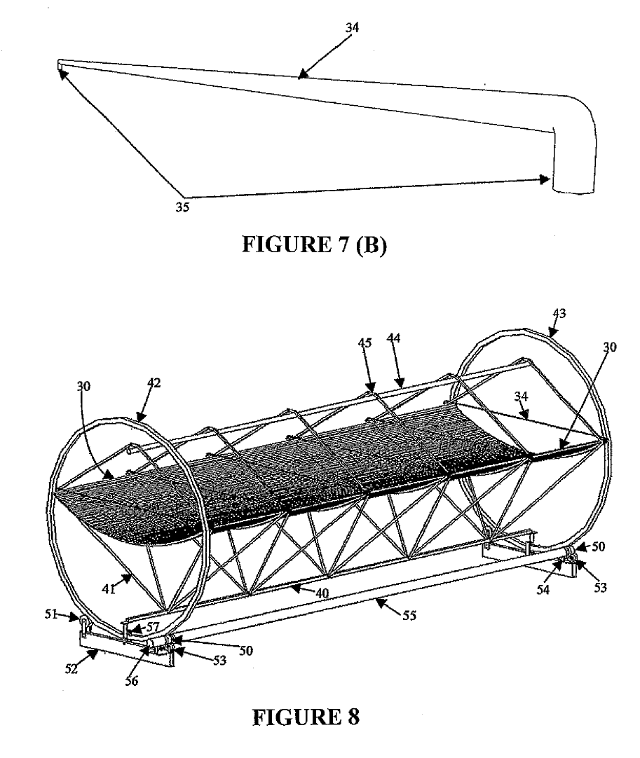

As shown in FIG. 7(a), a preferred chordal strap 34 is a thin metal rod (preferably of steel), at each end of which is a hook member 35. Each hook member is attached to a respective open end of the rib. The combination of the resilience of the rib, and the restraint provided by the hook members of the chordal strap, holds tips of the rib at the required distance apart.

Various forms of chordal strap may be used. A thin, metal rod is preferred because
1. it is stable in length when it has been locked in place and
2, it obscures very little of the area of the reflecting surface from incoming solar radiation.

A turnbuckle which connects wires attached to each end of a rib may be used, but this form of chordal strap is not preferred if the wires can stretch when they are under tension for a long period of time.

Another form of chordal strap is shown in FIG. 7(b).

The trough reflector constructed by this technique is a relatively lightweight structure. It is also a rigid structure (both transversely and longitudinally).

A trough reflector constructed in accordance with the first or second aspect of the present invention may be used advantageously in a collector of solar energy if it is mounted on a suitable space frame with an absorber tube (or other solar energy collecting device) mounted above the reflecting surface, at the focus of the parabolic reflector.

The tertiary objective of the invention is realised if such a trough reflector is used as shown in FIG. 8. In the solar collector illustrated in FIG. 8, the space frame supporting the trough reflector is a truss framework comprising a main strut (a “backbone strut”) 40 and a plurality of web struts 41. Each web strut 41 extends from an end of a respective rib 10 of the trough reflector to the backbone strut 40.

The backbone strut 40 and the edge support rails 20 are fixedly connected (typically, using bolts), at each end of the trough reflector, to respective hoop members 42 and 43. The hoop members 42 and 43 each have a horizontal axis and are formed from a strong material (they are preferably rolled from a single steel beam). The hoop members may have any one of a number of cross-sectional shapes. Those cross-sectional shapes for a hoop member include an “I” section, a composite “I” section (comprising two “back to back” “C” sections), a single “C” section, a rolled rectangular hollow section and flange, and a rectangular solid cross-section (This list is not exhaustive.) The important feature of the cross-section of the beam that is roiled to produce the hoop members 42 and 43 is that, when the hoop members are formed,
1. the outer surface of the hoop member must be a horizontal fine at the point where it meets the surface of a drive roller (a “pinch roller”) that
   (a) has a horizontal axis of rotation, and
   (b) is used to rotate the hoop member about its own horizontal axis; and
2. the hoop member must have at least one inner surface on which a “pinch bearing” can apply pressure to force the outer surface of the hoop member into contact with the associated drive or pinch roller.

In principle, since the hoop members 42 and 43 of the depicted solar energy collector will need to be rotated about their co-linear horizontal axes to track the sun from the horizon where the sun rises to the horizon where the sun sets, the hoop members 42 and 43 need not be entirely circular. The upper portions of the hoop members could be omitted and be replaced by, for example, a rigid chordal strut. However, in practice, it is easier, and costs less, to form each hoop member as a complete, circular hoop.

Reverting to the embodiment illustrated in FIG. 8, an absorber tube 44 is positioned above the trough reflector, at the focus of the parabolic reflecting surface. An absorber mounting framework, comprising a series of struts 45, each of which is connected to the absorber tube 44 and also to the ends of respective ribs 10 of the support frame, supports the absorber tube 44 in this location.

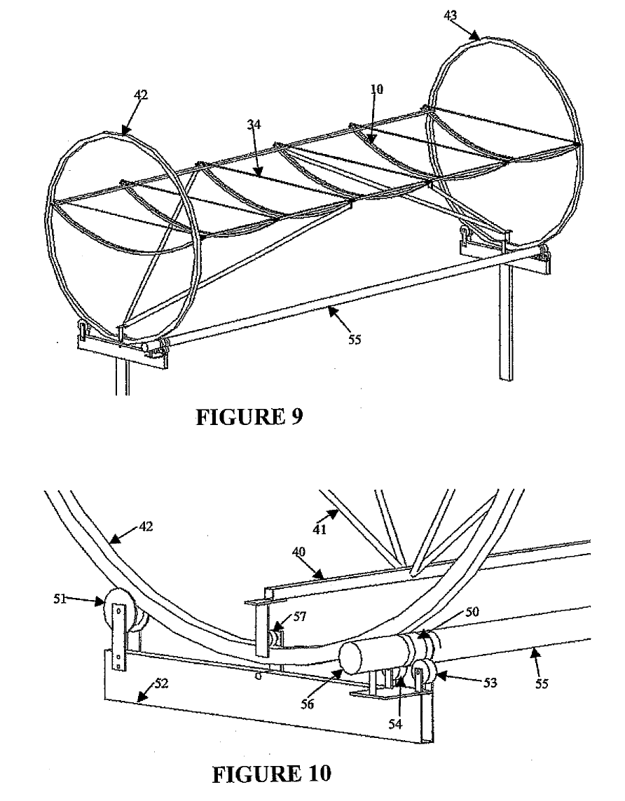

The space frame structure shown in FIG. 8 is a rigid, relatively lightweight structure. However, alternative space frame constructions may be used. For example, FIG. 9 shows the use of a “double-A” space frame structure, similar to that featured in the specification of U.S. Pat. No. 4,820,033, to connect the trough reflector of the present invention to the hoop members 42 and 43.

As shown particularly in FIG. 10, each hoop member 42, 43 is supported for rotation by (1) a respective support and guide wheel 51; (2) a pinch roller 50; and (3) a pair of idler wheels 53, 54. The support and guide wheel 51 and the pair of idler wheels 53, 54 are mounted on a respective wheel support beam 52. The idler wheels 53 and 54 actually provide a support for the associated pinch roller 50, so the support of the hoop member 42 (in FIG. 10) by the idler wheels is an indirect support.

A respective inner pinch bearing 57 is associated with each hoop member of the solar collector. Each pinch bearing 57 is mounted so that it applies pressure to its associated hoop member, to keep the outer surface of the hoop member in contact with its associated pinch roller 50.

The pinch rollers 50 can be connected together by a torque tube 55. The torque tube 55 is rotated by a motor and gearbox combination 56, which is also mounted on one of the wheel support beams 52. Using a torque tube 55 to connect the pinch rollers provides increased control over longitudinal distortion that may occur due to torsional flexibility in the trough structure.

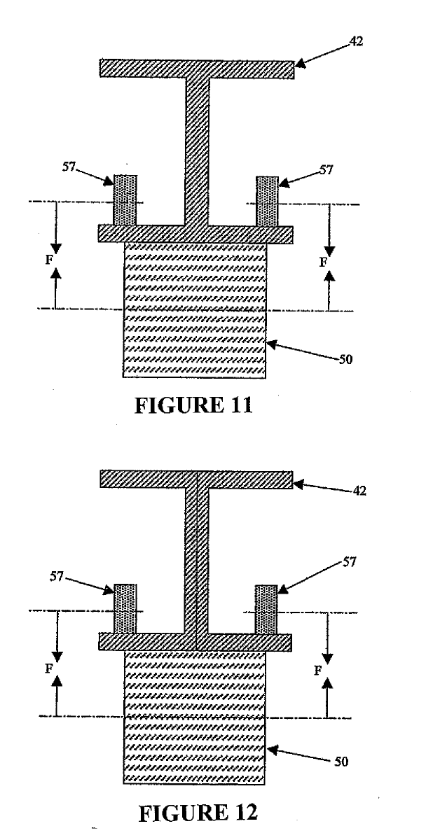

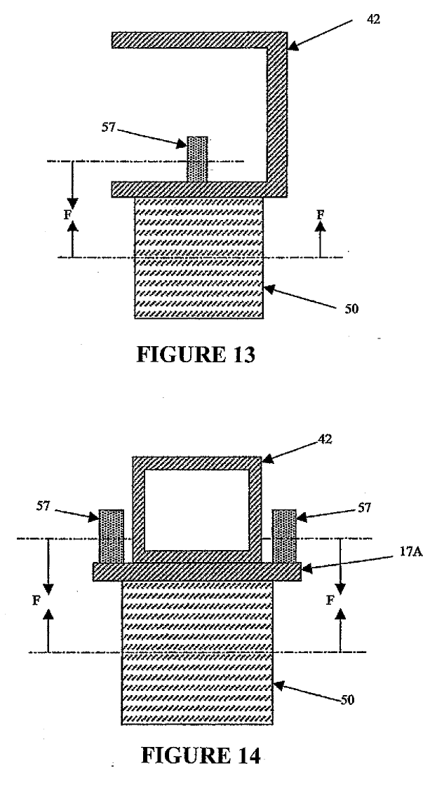

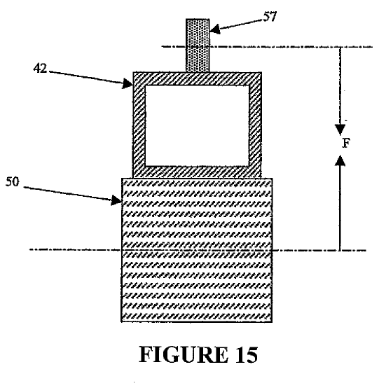

FIG. 11 to FIG. 15 each illustrate a different pinch roller and pinch bearing combination that may be used to drive a hoop member having a certain cross-sectional profile. In particular,
1. FIG. 11 shows a hoop member 42 having an “I” section profile, driven by a pinch roller 50, with two pinch bearings 57;
2. FIG. 12 shows a hoop member 42 having a composite “I” section profile (two back-to-back “C” sections), driven by a pinch roller 50, with two pinch bearings 57;
3. FIG. 13 shows a hoop member 42 having a single “C” section profile, driven by a pinch roller 50, with a single pinch bearing 57;
4. FIG. 14 shows a hoop member 42 having a composite box-and-plate section profile, driven by a pinch roller 50, with two pinch hearings 57; and
5. FIG. 15 shows a hoop member 42 having a hollow rectangular box section profile, driven by a pinch roller 50, with a single pinch bearing 57.

It should be appreciated that although, for convenience, the pinch bearings have been shown in FIG. 11 to FIG. 15 as apparently mounted directly above the pinch rollers, the pinch bearings can be (and usually will be) positioned away from their associated pinch roller (as they are in the embodiments illustrated in FIG. 8 to FIG. 10).

For single axis tracking of the sun, the horizontal axes of rotation of the hoop members 42 and 43 can be aligned in any orientation at the location in which the solar energy collector is used. For two-axes tracking of the sun, the support blocks 52 at each end of the solar concentrator will be mounted on a base frame that is partially rotatable about a second (vertical) axis. A separate motor and gearbox will be used to rotate the base frame about its second axis.

A micro-processor will normally be used to control the (or each) motor, to move the solar energy concentrator to track the sun, and (with an appropriate warning mechanism) to “park” the solar energy concentrator in a suitable position when wind speeds above a predetermined value are experienced.

A solar energy concentrator or collector, which includes the trough reflector of the present invention, and is preferably constructed as shown in FIG. 10, is ideally suited for the following uses:
the heating of heat transfer fluids for use in heat applications;
the generation of steam;
the thermal-detoxification or photo-detoxification of waste products;
the generation of electricity using concentrating photovoltaic devices.

This list is not exhaustive.

1. A method of constructing a trough reflector for a solar energy collector, said method comprising the sequential steps of
(a) positioning an array of spaced apart, transverse ribs on a jig, each rib having a top surface that has a profile which is a parabola; each rib having an aperture adjacent to each end of rib, each aperture extending at least partially through the rib from the top surface thereof;
(b) positioning a reflective surface comprising at least one rectangular sheet having an upper surface which is highly reflective of solar energy on said ribs, said reflective surface having dimensions such that, when so positioned, it is in contact with said top surfaces of said ribs, with parabolic end edges and with substantially linear side edges; said side edges being positioned adjacent to but inwardly of the respective ends of said ribs;
(c) positioning at least one side edge support rail on each of said linear side edges, said at least one side edge support rail being positioned adjacent to respective ends of said ribs; each side edge support rail comprising an elongate metal strut which has a cross-sectional shape that comprises
(i) a planar web member;
(ii) an inner flange member and an outer flange member, each of said flange members extending orthogonally from a respective edge of said web member, to form a pair of parallel flange members; and a lip member extending orthogonally from the edge of said outer flange member which is remote from said web member, a short distance towards said inner flange member;
(iii) each side edge support rail having a portion of its lip member removed from each region of said side edge support rail which overlies one of said ribs; each side edge support rail being positioned to have at least one respective linear edge of said reflective surface positioned on its lip member and in contact with, its outer flange member; said mounting of said side edge support rails being effected by a plurality of bolts, each of said bolts being passed through a respective clearance aperture in said web member of one of said side edge support rails, and through a clearance aperture in said reflective surface adjacent to one of said linear side edges, to engage with threads which are formed in said apertures in said ribs or are provided by a nut, said bolts being lightly tightened; and
(d) tightening of said mounting bolts to cause each inner flange member of said support rails to apply a downwards force onto said linear edge region of the reflective sheet which is inside the mounting bolts, and to cause each lip member to apply an upwards force to said linear edge region of the reflective surface which overlies said lip member, thereby applying a turning moment to said linear edge regions of said reflective surface to make said reflective surface conform closely to the parabolic shape of said upper surface of said ribs.

2. A method of constructing a trough reflector for a solar energy concentrator, as defined in claim 1, in which each rib is formed from a panel, or comprises a plurality of tabs pressed from, or attached to, a panel.

3. A method of constructing a trough reflector for a solar energy concentrator, said method comprising the sequential steps of:
(a) positioning an array of spaced apart, flexible and resilient, transverse ribs on a jig, each rib having a top surface that has a profile which is an arc of a circle; each rib having an aperture adjacent to each end of the rib, each aperture extending at least partially through the rib from the top surface thereof;
(b) positioning, on said ribs, a reflective surface comprising either at least one rectangular sheet having an upper surface which is highly reflective of solar energy or a plurality of panels each having an upper surface which is highly reflective of solar energy, said reflective surface having dimensions such that, when so positioned, it is in contact with said top surfaces of said ribs, with arcuate end edges and with substantially linear side edges; said side edges being positioned adjacent to but inwardly of the respective ends of said ribs;
(c) positioning at least one side edge support rail on each of said linear side edges, said at least one side edge support rail being positioned adjacent to respective ends of said ribs; each side edge support rail comprising an elongate metal strut which has a cross-sectional shape that comprises
(i) a planar web member;
(ii) an inner flange member and an outer flange member, each of said flange members extending orthogonally from a respective edge of said web member, to form a pair of parallel flange members; and (iii) a lip member extending orthogonally from the edge of said outer flange member which is remote from said web member, a short distance towards said inner flange member; each side edge support rail having portions of its lip member removed to form respective cut-outs from the regions of said side edge support rail which overlie said ribs; each side edge support rail being positioned to have at least respective linear edge of said reflective surface positioned on its lip member and in contact with its outer flange member; said mounting of said side edge support rails being effected by a plurality of bolts, each of said bolts being passed through a respective clearance aperture in said web member of one of said side edge support rails, and through a clearance aperture in said reflective surface adjacent to one of said linear side edges, to engage with threads which are formed in said apertures in said ribs or are provided by a nut, said bolts being lightly tightened;
(d) applying a force progressively to each end of each rib in the direction of the other end of the rib, to reduce the distance apart of the ends of each rib and to change the shape of said top surface of each rib from substantially an arc of a circle to substantially parabolic; but holding said applied force at a value less than the force required to cause the top surface of each rib to be parabolic;
(e) tightening said bolts to apply a turning moment to the edge regions of said reflective surface;
(f) continuing the progressive application of said force until the top surface of each rib becomes substantially parabolic, said continuation of the progressive application of said force causing said reflective surface to pressed into firm contact with said top surfaces of said ribs and said reflective surface to be fixed against said top surfaces of said ribs;
(g) connecting a respective chordal strap to each end of each rib to hold its associated rib in the shape reached at the conclusion of the application of said force; then
(h) relaxing and removing said force.

4. A method of constructing a trough reflector for a solar energy concentrator, as defined in claim 3, in which each of said arcuate ribs has a cross-section selected from the group consisting of: a hollow rectangular cross-section, a “T” cross-section, an “T” cross-section and a “C” cross-section.

5. A method of constructing a trough reflector for a solar energy concentrator, as defined in claim 3, in which said chordal strap comprises a thin metal rod with a respective hook member rigidly attached to each end thereof.

6. A method of constructing a trough reflector for a solar energy concentrator, as defined in claim 3, in which, prior to the first step of said method, said reflective surface is initially not a reflective surface, said method including an extra, concluding step of applying a highly reflective material to said reflective surface.

7. A trough reflector constructed in accordance with the method of claim 3.

8. A trough reflector as defined in claim 7, in which the cross-sectional shape of each side edge support rail includes a lip member extending
(a) orthogonally from the edge of said inner flange member which is remote from said web member,
(b) a short distance towards said outer flange member.

9. A trough reflector as defined in claim 8, in which the cross-sectional shape of each side edge support rail includes a respective small flange member extending from each lip member; each small flange member extending
(a) orthogonally to the plane of the lip members,
(b) from the edge of the lip member that is remote from its associated inner or outer flange member, and
(c) towards said web member.

10. A solar energy concentrator including a trough reflector as defined in claim 7.

11. A solar energy concentrator as defined in claim 10, in which said trough reflector is supported on at least two spaced apart hoop members; each hoop member being mounted for rotation about a horizontal axis; a respective hoop member being connected to said side edge support rails at each end of said trough reflector.

12. A solar energy concentrator as defined in claim 11, in which said trough reflector is also supported on a space frame, and an energy collecting device is mounted at the linear focus of the parabolic reflecting surface of said trough reflector.

13. A solar energy concentrator as defined in claim 12, in which said energy collecting device is an absorber tube.

14. A solar energy concentrator as defined in claim 12, in which said space frame comprises a main strut and a plurality of web struts; said main strut being positioned underneath said trough reflector and extending in a direction that is parallel to the elongate direction of said side edge support rails; each web strut being connected to said main strut and also to an end of a respective one of said ribs.

15. A solar energy concentrator as defined in claim 12, in which said space frame comprises two pairs of struts, one end of the struts of each pair being connected to respective ends of one of said ribs, the other ends of the struts of each pair being connected to a respective hoop member at the end of said trough reflector at a point which is
(a) below said trough reflector and
(b) substantially equi-distant from the ends of said edge support side rails connected to the respective hoop member.

16. A solar energy concentrator as defined in claim 11, in which
(a) each hoop member is supported for rotation by a respective support and guide wheel and by a respective pinch roller;
(b) each pinch roller is supported on a respective pair of idler wheels;
(c) a respective pinch bearing is associated with each hoop member, each pinch bearing being mounted so that it applies pressure to the inside surface of its associated hoop member, to maintain the contact between the outside surface of the hoop member and its associated pinch roller.

17. A solar energy concentrator as defined in claim 16, in which the pinch roller associated with one of said hoop members is connected to a motor for rotation; rotation of a pinch roller by said motor causing said hoop members to be rotated simultaneously.

18. A solar energy concentrator as defined in claim 17, in which adjacent pinch rollers of said concentrator are connected by a torque tube.

19. A solar energy concentrator as defined in claim 17, in which activation of said motor is controlled by a microprocessor.

20. A solar energy concentrator as defined in claim 10, mounted on a base frame which is rotatable about a vertical axis.
